(19) United States
(12) Patent Application Publication
(10) Pub. No.: US 2014/0010560 A1
(43) Pub. Date: Jan. 9, 2014

(54) IMAGE FORMING APPARATUS FORMING TONER IMAGE ON IMAGE CARRIER

(71) Applicant: Konica Minolta, Inc., Chiyoda-ku (JP)

(72) Inventors: Mitsuru OBARA, Toyohashi-shi (JP); Shigeki NAIKI, Toyokawa-shi (JP); Masahiro KOUZAKI, Toyohashi-shi (JP); Munenori NAKANO, Toyokawa-shi (JP)

(21) Appl. No.: 13/932,193

(22) Filed: Jul. 1, 2013

(30) Foreign Application Priority Data
Jul. 3, 2012 (JP) 2012-149703

(51) Int. Cl. G03G 15/00

(52) U.S. Cl. CPC G03G 13/22
USPC 399/49

(57) ABSTRACT

An image forming apparatus for forming a toner image on an image carrier, including: a patch former that forms a solid and a non-solid patch on the image carrier under different image formation conditions; a measurer that measures amounts of toner adhering to the solid and the non-solid patch; a determiner that determines image density properties indicating a relationship between an image formation condition and an amount of adhering toner, based on both (i) a relationship between an image formation condition applied to the solid patch and the amount of toner adhering to the solid patch, and (ii) a relationship between an image formation condition applied to the non-solid patch and the amount of toner adhering to the non-solid patch; and a setter that sets an appropriate image formation condition for forming a toner image having a desired density on the image carrier according to the image density properties.

This application is based on applications No. 2012-149703 filed in Japan, the contents of which are hereby incorporated by reference.

### BACKGROUND OF THE INVENTION

(1) Field of the Invention

The present invention relates to an image forming apparatus that forms toner image.

(2) Related Art

In electrophotographic image forming apparatuses such as copiers and printers, the amount of toner adhering to their photosensitive drums might change even under the same image formation condition, due to changes in temperature and humidity within the apparatuses and the deterioration of their components such as the photosensitive drum as an example of the image carrier. The changes in the amount of toner cause changes in the density of the toner image, which leads to a problem of unstable image quality.

Therefore, some image forming apparatuses are provided with the function of image stabilization control for adjusting the amount of the adhering toner.

The image stabilization control is performed in order to achieve a desired amount of adhering toner. For this purpose, a solid toner patch (hereinafter “solid patch”) corresponding to the desired amount of adhering toner is formed on the image carrier, and is irradiated with light. The reflection of the light is received by a sensor, which optically measures the amount of toner contained in the solid patch. Based on the result of this measurement, the amount of the adhering toner is adjusted by changing the image formation condition such as the charging voltage and the development bias voltage.

With this control method, however, there is a possibility that the amount of adhering toner cannot be accurately measured when the desired amount is large (i.e. with high density).

This is because the toner particles are likely to stack only in the height (thickness) direction when the solid patch has a high density. After the density has been increased to some extent, the amount of reflected light from the solid patch shows almost no change even when the density of the solid patch is increased further.

Japanese Patent Application Publication No. 2010-49233 discloses a technology for accurately measuring the amount of adhering toner when the solid patch has a high density. According to this disclosure, an image unit having a plurality of photo detectors that receive reflected light from the solid patch and obtain information about the height (thickness) of the solid patch and the toner density, and the amount of adhering toner is calculated based on the information.

This structure improves the accuracy in measuring the amount of adhering toner even when the amount of toner contained in the solid patch is increased.

However, according to the disclosure of the publication described above, an imaging unit provided with a plurality of photo detectors is necessary to obtain the information about the height of the solid patch. Since such an imaging unit having a plurality of photo detectors is expensive, the cost efficiency could be low.

### SUMMARY OF THE INVENTION

An aim of the present invention is to provide an image forming apparatus that is capable of appropriately setting the image formation condition, and forming an image with a desired amount of adhering toner without lowering the cost efficiency.

The aim described above is achieved by an image forming apparatus for forming a toner image on an image carrier, comprising: a patch former that forms a solid patch and a non-solid patch respectively on a first area and a second area of the image carrier, under different image formation conditions, the solid patch being a toner patch to which toner uniformly adheres, the non-solid patch being a toner patch including: a toner adhesion part to which a greater amount of toner adheres per unit area compared with the solid patch; and a non-adhesion part to which no toner adheres; a measurer that optically measures an amount of toner adhering to the solid patch and an amount of toner adhering to the non-solid patch; a determiner that determines image density properties indicating a relationship between an image formation condition and an amount of adhering toner, based on both (i) a first relationship between an image formation condition applied to the solid patch and the amount of toner adhering to the solid patch, and (ii) a second relationship between an image formation condition applied to the non-solid patch and the amount of toner adhering to the non-solid patch; and a setter that sets an appropriate image formation condition for forming a toner image having a desired density on the image carrier according to the image density properties determined by the determiner.

### BRIEF DESCRIPTION OF THE DRAWINGS

In the drawings:

FIG. 1 is a schematic diagram showing an overall structure of a printer;

FIG. 2 shows example toner patches formed on a photosensitive drum;

FIG. 3 is a schematic diagram illustrating the structure of an IDC sensor for the Y color;

FIG. 4A shows a beam spot formed when a solid patch formed on the surface of the photosensitive drum is irradiated with a laser beam emitted by a light-emitter of the IDC sensor;

FIG. 4B shows a beam spot formed when a non-solid patch formed on the surface of the photosensitive drum is irradiated with the laser beam emitted by the light-emitter of the IDC sensor;

FIG. 5 is a schematic diagram illustrating the structure of an IDC sensor for the K color;

FIG. 6 is a block diagram showing the structure of a control system for an image formation unit provided in a control unit;

FIG. 7 is a flowchart showing a toner patch formation control;

FIG. 8 shows an example of a voltage table;

FIG. 9 is a graph showing the relationship between a development bias voltage and an average output voltage of the IDC sensor in the case of the toner patch;

FIG. 10 is a graph showing the relationship between an average output voltage of the IDC sensor in the case of the solid patch and the amount of the toner adhering to the solid patch;

FIG. 11 is a graph showing the relationship between an average output voltage of the IDC sensor in the case of the non-solid patch and the amount of the toner adhering to toner adhesion parts of the non-solid patch, which has been converted into the amount of the toner adhering to the solid patch; and

FIG. 12 is an example graph showing determined development properties (in solid line).

### DESCRIPTION OF PREFERRED EMBODIMENTS

The following describes embodiments of the image forming apparatus pertaining to the present embodiment.

### <Structure of Image Forming Apparatus>

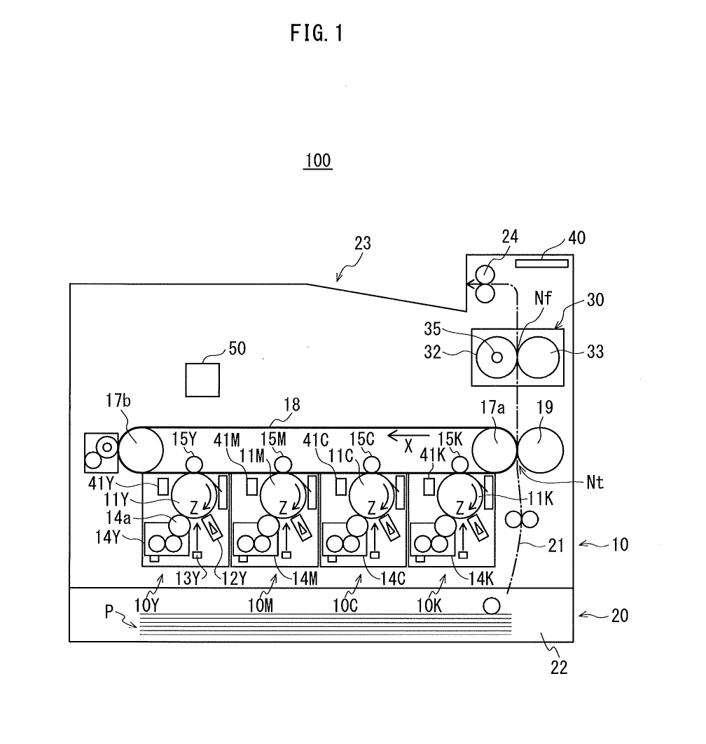

FIG. 1 is a schematic diagram showing an overall structure of a tandem color printer (hereinafter simply referred to as “printer”) 100, which is an example of an image forming apparatus pertaining to an embodiment of the present invention.

The printer 100 executes image formation jobs by a well-known electrophotographic method, based on image data or the like input from an external terminal device via a network (e.g. LAN). The printer 100 includes an image processor 10, a paper feeder 20, a fixing unit 30, an operation unit 40 and a control unit 50.

The image processor 10 includes image formation units 10Y, 10M, 10C and 10K, an intermediate transfer belt 18, and so on.

The intermediate transfer belt 18 is a cylindrical endless belt. The intermediate transfer belt 18 is provided substantially in the middle of the printer 100 with respect to the vertical direction, and is wound around a driving roller 17a and a tension roller 17b which are provided with a gap therebetween along the horizontal direction. The rotation area (circumferential movement area) of the intermediate transfer belt 18 is elongated in the horizontal direction. The intermediate transfer belt 18 is rotated in the direction indicated by the arrow X as the driving roller 17a is rotated. The driving roller 17a is located at one end (the right end shown in FIG. 1) of the intermediate transfer belt 18.

The image formation units 10Y, 10M, 10C and 10K are arranged in this order along the running direction of the lower portion of the intermediate transfer belt 18.

The image formation units 10Y, 10M, 10C and 10K are respectively provided with photosensitive drums 11Y, 11M, 11C and 11K, each of which is rotated in the direction indicated by the arrow Z and faces the intermediate transfer belt 18. The image formation units 10Y, 10M, 10C and 10K use the photosensitive drums 11Y, 11M, 11C and 11K to form toner images of the colors of yellow (Y), magenta (M), cyan (C) and black (K), respectively.

The image formation units 10Y, 10M, 10C and 10K are only different in the color of toner to use for forming toner images, and have a substantially same structure. Therefore, the following describes only the structure of the image formation unit 10Y, and the explanations of the other image formation units 10M, 10C and 10K are omitted.

The image formation unit 10Y has an exposurer 13Y and a charger 12Y. The exposurer 13Y is located to face the lower portion of the photosensitive drum 11Y. The charger 12Y is located upstream of the exposurer 13Y with respect to the rotational direction of the photosensitive drum 11Y.

The surface of the photosensitive drum 11Y is uniformly charged by the charger 12Y. The surface of the photosensitive drum 11Y is exposed to radiation of a laser beam emitted by the exposurer 13Y, and thus an electrostatic latent image is formed on the surface of the photosensitive drum 11Y.

A developer 14Y is provided downstream of the exposure 13Y with respect to the rotational direction of the photosensitive drum 11Y. Y color toner housed within the developer 14Y is transported by the rotation of the developing roller 14a located to face the photosensitive drum 11Y.

The developing roller 14a is applied with development bias voltage Vb. Toner transported by the developing roller 14a adheres to the electrostatic latent image formed on the surface of the photosensitive drum 11Y by the effect of the electric field formed between the developing roller 14a and the photosensitive drum 11Y due to the difference between the development bias voltage Vb applied by the developing roller 14a and the voltage on the surface the photosensitive drum 11Y after the exposure. Thus the electrostatic latent image on the surface of the photosensitive drum 11Y is developed with toner, and a Y color toner image is formed on the surface of the photosensitive drum 11Y.

The development bias voltage Vb is applied to the developing roller 14a of each of the developers 14M, 14C and 14K in the same manner.

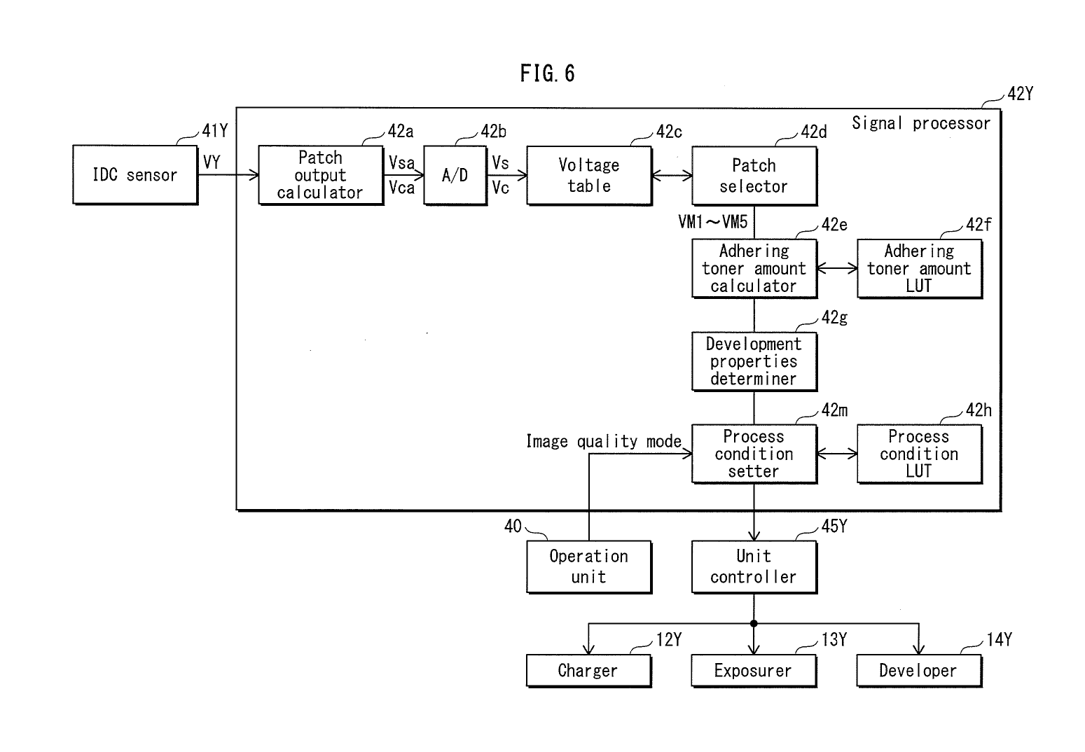

Each of the charger 12Y, the exposurer 13Y and the developer 14Y included in the image formation unit 10Y is controlled by a unit controller 45Y (see FIG. 6) so that the Y color toner image is formed on the surface of the photosensitive drum 11Y according to a process condition determined for each image formation job.

An IDC sensor 41Y is provided downstream of the developer 14Y in the rotational direction of the photosensitive drum 11Y. The IDC sensor 41Y is used for determining the development properties of the developer 14Y.

Specifically, the IDC sensor 41Y is located at a position near the photosensitive drum 11Y, between the developer 14Y and the upper part (the primary transfer position) of the photosensitive drum 11Y facing the intermediate transfer belt 18, along the rotational direction of the photosensitive drum 11Y.

The IDC sensor 41Y detects the toner patch formed on the photosensitive drum 11Y. Not only the toner patch on the image formation unit 10Y, but also the toner patches on the other image formation units 10M, 10C and 10K are detected by the IDC sensors 41M, 41C and 41K, respectively.

A primary transfer roller 15Y is provided within the rotation area (circumferential movement area) of the intermediate transfer belt 18 so as to face the photosensitive drum 11Y with the intermediate transfer belt 18 interposed therebetween. The primary transfer roller 15Y is applied with primary transfer bias voltage. The toner image formed on the surface of the photosensitive drum 11Y is subject to primary transfer to the intermediate transfer belt 18 by the effect of the electric field formed between the primary transfer roller 15Y applied with the primary transfer bias voltage and the photosensitive drum 11Y.

Similarly, primary transfer rollers 15M, 15C and 15K facing the photosensitive drums 11M, 11C and 11K with the intermediate transfer belt 18 interposed therebetween are provided above the image formation units 10M, 10C and 10K, respectively. The toner images formed on the surface of the photosensitive drums 11M, 11C and 11K are subject to primary transfer to the intermediate transfer belt 18 by the effect of the electric fields formed between the primary transfer rollers 15M, 15C and 15K applied with the primary transfer bias voltage and the photosensitive drums 11M, 11C and 11K, respectively.

In the case of full-color image formation, the image formation units 10Y, 10M, 10C and 10K perform their image formation operations in this order at different timings with reference to the timing of the operation by the image formation unit 10Y, so that the toner images formed on the photosensitive drums 11Y, 11M, 11C and 11K in the respective colors are transferred onto the same area on the intermediate transfer belt 18 running circularly.

Due to the circular running of the intermediate transfer belt 18, the duplicative toner images transferred onto the same area of the intermediate transfer belt 18 are transported to the pressing position (secondary transfer position) Nt where the secondary transfer roller 19 is pressed by the driving roller 17a with the intermediate transfer belt 18 interposed therebetween.

According to the timing of transporting the duplicative toner images in the respective colors, formed on the intermediate transfer belt 18, to the secondary transfer position Nt, a recording sheet P is transported from a paper feed cassette 22 provided in the paper feeder 20 to the second transfer position Nt along the sheet transport path 21.

When the recording sheet P thus transported passes through the secondary transfer position Nt, the duplicative toner images on the intermediate transfer belt 18 are subject to secondary transfer onto the recording sheet P by the effect of the electric field formed between the secondary transfer roller 19 applied with the secondary transfer bias voltage and the intermediate transfer belt 18.

The recording sheet P, which has passed through the secondary transfer position Nt, is further transported to the fixing unit 30 located downstream of the secondary transfer position Nt in the sheet transport direction.

The fixing unit 30 includes a heating roller 32 and a pressure roller 33 which are pressed against each other. A fixing nip Nf is formed by the pressure. A halogen heater lamp 35 is provided at the central axis of the heating roller 32, and the temperature of the heating roller 32 is kept at the fixing temperature by the halogen heater lamp 35.

When the recording sheet P, which has passed through the secondary transfer position Nt, passes through the fixing nip Nf formed between the heating roller 32 kept at the fixing temperature and the pressure roller 33, the toner images in the respective colors, which have been subject to the secondary transfer onto the recording sheet P, are fixed on the recording sheet P by heat and pressure. The recording sheet P, which have passed through the fixing unit 30, is ejected onto a catch tray 23 by an ejection roller 24.

The description above explains the case of an image formation job for forming a full-color image. In the case of a job for forming a monochrome image, only a selected one of the image formation units (e.g. the image formation unit 10K for the K color) is driven, and the toner image formed on the photosensitive drum provided in the selected image formation unit is first subject to the primary transfer onto the intermediate transfer belt 18, is next subject to the secondary transfer onto the recording sheet P at the secondary transfer position Nt, and is then fixed to the recording sheet P by the fixing unit 30. Finally, the recording sheet P is ejected onto the catch tray 23.

The operation unit 40 is located on the front top of the printer 100 so that users can easily operate. The operation unit 40 has a plurality of keys for receiving instructions from a user, such as switching between image formation modes such as the full-color mode and the monochrome mode, setting of the size of the recording sheet P, and selection from image quality modes applied to the reproduction image.

Here, the image quality modes applied to the reproduction image include a character mode for improving the reproduction quality of characters and a photo mode for improving the reproduction quality of middle tones of photographs or the like.

Upon receiving an instruction from a user, the operation unit 40 sends the instruction to the control unit 50.

The control unit 50 collectively controls the image processor 10, the paper feeder 20, the fixing unit 30 and so on according to the instruction from the user received by the operation unit 40, and smoothly performs an image formation instructed by the user. When one of the image quality modes is selected by the user, the image formation is performed based on a process condition for the selected mode.

The process condition is determined for each image formation job according to the development properties which are determined by the image stabilization control. The image stabilization control is performed separately from the image formation job.

The image stabilization control is performed for each of the image formation units 10Y through 10K in order to determine the development properties of each image formation unit.

As for the image formation unit 10Y, (a) a plurality of toner patches in Y color are formed on the photosensitive drum 11Y while changing the value of the development bias voltage Vb as the image formation condition, (b) the toner patches thus formed are irradiated with light, and the IDC sensor 41Y receives the reflected light from each patch and obtains the amount of adhering toner per unit area (g/m²) for each patch based on the results of the receiving, and (c) obtains, for each patch, the relationship between the development bias voltage Vb and the amount of adhering toner of the patch, as the development properties. For each image formation job, an appropriate process condition for the job is determined by using the development properties obtained by the image stabilization control. The same applies to the image formation units 10M through 10K.

The image stabilization control is repeatedly performed with given timing, for example every time the printer 100 is powered on or every time the image formation is performed on a predetermined number of sheets (e.g. 1000 sheets).

### <Structure of Toner Patch>

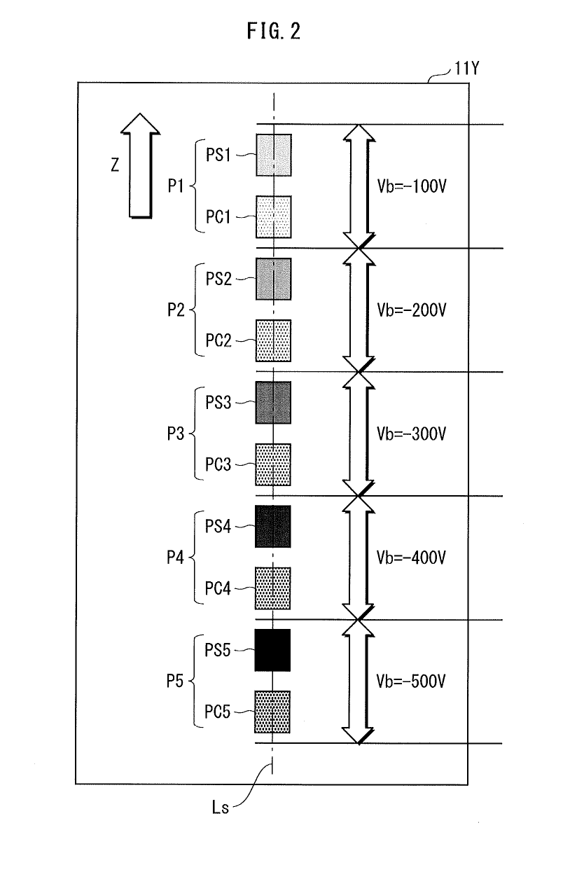

FIG. 2 shows example toner patches formed on the photosensitive drum 11Y. This drawing shows a developed view of the surface of the photosensitive drum 11Y. The direction indicated by the arrow Z corresponds to the rotational direction of the photosensitive drum 11Y.

As shown in the drawing, a plurality of toner patches are arranged along the rotational direction of the photosensitive drum 11Y. In the example shown in the drawing, ten patches, namely PS1, PC1, . . . , PS5 and PC5 are arranged from the downstream to the upstream of the rotational direction at intervals.

Each of the toner patches PS1, PS2, PS3, PS4 and PS5 is formed on a rectangular first area (patch area) with sides of approximately 1 cm to 2 cm, to which Y color toner uniformly adheres (These patches are hereinafter referred to as “solid patches”).

On the other hand, each of the toner patches PC1, PC2, PC3, PC4 and PC5 is formed on a rectangular second area (patch area) which is same in size as the solid patches, but includes toner adhesion parts where toner adheres and non-adhesion parts where no toner adheres (These patches are hereinafter referred to as “non-solid patches”).

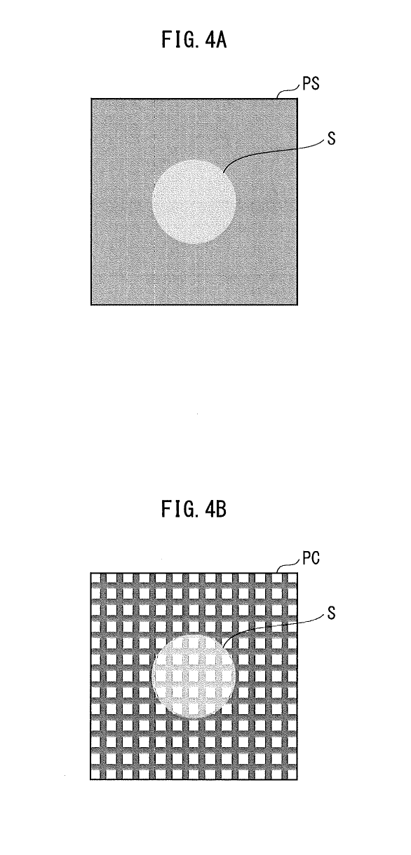

In this example, each non-solid patch has a lattice-like shape (See FIG. 4B) formed from a plurality of vertical lines and a plurality of horizontal lines, which are perpendicular to each other. The vertical and horizontal lines have a same width, and the interval between adjacent two lines is the same as the width of the lines. The width of the lines is, for example, approximately 100 μm, but is not limited to this. In the following description, the solid patches PS1 through PS5 may be collectively called “the solid patches PS” when it is not necessary to distinguish them from each other. Similarly, the non-solid patches PC1 through PC5 may be collectively called “the non-solid patches” when it is not necessary to distinguish them from each other. Furthermore, the solid patches and the non-solid patches may be collectively called “toner patches” when it is not necessary to distinguish them from each other.

In each solid patch PS, the patch area is consisted of a single toner adhesion part. Therefore, the ratio of the toner adhesion part to the patch area (i.e. the B/W ratio) is 100%. In each non-solid patch PC, the B/W ratio is 50%, because the patch area is formed such that the total area of the toner adhesion parts in the patch area and the total area of the non-adhesion parts in the patch area will be the same.

Suppose that the solid patch PS1 and the non-solid patch PC1 constitute a patch pair P1, the solid patch PS2 and the non-solid patch PC2 constitute a patch pair P2, the solid patch PS3 and the non-solid patch PC3 constitute a patch pair P3, the solid patch PS4 and the non-solid patch PC4 constitute a patch pair P4, and the solid patch PS5 and the non-solid patch PC5 constitute a patch pair P5. Each pair is formed such that the amount of toner per unit area (g/m²) adhering to the toner adhesion part of the solid patch and the amount of toner per unit area (g/m²) adhering to the toner adhesion parts of the non-solid patch are the same, and the amount of adhering toner per unit area (i.e. the density) gradually increases in the order from the patch pair P1 to the patch pair P5.

Specifically, the control for developing the Y-color toner images is performed on each of the patches P1 through P5 under the same charging and exposure conditions, but under different development conditions. In this example, the development bias voltage Vb, as a development condition, is different among the patches P1 through P5.

More specifically, the patch pair P1 is formed under the condition that the development bias voltage Vb is −100 V, the patch pair P2 is formed under the condition that the development bias voltage Vb is −200 V, the patch pair P3 is formed under the condition that the development bias voltage Vb is −300 V, the patch pair P4 is formed under the condition that the development bias voltage Vb is −400 V, and the patch pair P5 is formed under the condition that the development bias voltage Vb is −500 V.

In each pair, the solid patch PS and the non-solid patch PC are formed by developing an electrostatic latent image on the photosensitive drum 11Y at the same development bias voltage Vb. Therefore, the amount of toner per unit area in the toner adhesion part of the solid patch PS is the same as the amount of toner per unit area in the toner adhesion parts of the non-solid patch PC.

The development bias voltage Vb is changed according to the timings with which the electrostatic latent images for the patches P1 through P5, formed on the photosensitive drum 11Y, pass through the development position where each image faces the developing roller 14a.

Each of the patches P1 through P5 on the photosensitive drum 11Y, which have been developed, is detected by the IDC sensor 41Y when it passes through the detection area of the IDC sensor 41Y according to the rotation of the photosensitive drum 11Y. The dashed line Ls shown in the drawing represents a detection line of the IDC sensor 41Y on the photosensitive drum 11Y being rotated, along which the IDC sensor 41Y detects the toner patches.

### <Structure of IDC Sensor 41Y>

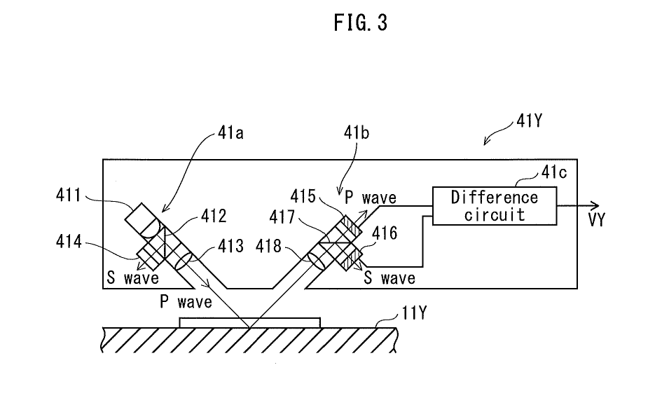

FIG. 3 is a schematic diagram illustrating the structure of the IDC sensor 41Y.

As shown in the drawing, the IDC sensor 41Y includes a light-emitter 41a, a light-receiver 41b, and a difference circuit 41c.

The light-emitter 41a includes a laser beam source 411, a first polarization prism 412, a first collecting lens 413, and a light absorber element 414.

The laser beam source 411 emits a laser beam having a wavelength falling within the range of visible light to infrared light toward a predetermined area on the surface of the photosensitive drum 11Y. The laser beam having such a wavelength will be absorbed in K color toner, but will not be absorbed in Y, M or C color toner and will be reflected.

The first polarization prism 412 separates the laser beam emitted by the laser beam source 411 into a P wave and an S wave.

The first collecting lens 413 collects the P wave separated by the first polarization prism 412, and leads the P wave to the surface of the photosensitive drum 11Y.

FIGS. 4A and 4B show a beam spot S formed on the surface of the photosensitive drum 11Y when the surface is irradiated with the P wave of the laser beam collected by the first collecting lens 413. FIG. 4A shows the ease the solid patch PS is irradiated, and FIG. 4B shows the case the non-solid patch PC is irradiated.

The diameter of the beam spot S is smaller than the patch formation area where the solid patch PS is formed and the patch formation area where the non-solid patch PC is formed (i.e. the beam spot S is entirely contained within each area), and segments of a plurality of vertical and horizontal lines (corresponding to some of the toner adhesion parts) of the non-solid patch PC are contained within the beam spot S. For example, when the sides of the patch formation area have a length of approximately 1 cm to 2 cm and each of the vertical and horizontal lines of the non-solid patch PC has a width of approximately 100 μm, the diameter of the beam spot S will be approximately 1 mm to 2 mm.

Returning to FIG. 3, the light absorber element 414 absorbs the S wave separated by the first polarization prism 412.

(a) When Y color toner is adhering to the surface of the photosensitive drum 11Y, the P wave, which has passed through the first collecting lens 413 and has reached the surface of the photosensitive drum 11Y, partially collides with Y color toner particles contained in the toner adhesion part and is diffusely or specularly reflected off the particles, and the remaining portion of the P wave passes through the gaps among the toner particles and reaches the surface of the photosensitive drum 11Y, and is then specularly reflected off the surface. On the other hand, (b) when Y color toner does not exist on the surface of the photosensitive drum 11Y, the entire P wave is specularly reflected off the surface of the photosensitive drum 11Y, and travels to the light-receiver 41b. Note that the portion of P wave specularly reflected is not subject to polarization, and the portion of the P wave diffusely reflected is subject to polarization.

The light-receiver 41b includes a first: light-receiver element 415, a second light-receiver element 416, a second polarization prism 417 and a second collecting lens 418.

The second collecting lens 418 collects the laser beam reflected off the surface of the photosensitive drum 11Y and the Y color toner, and leads the beam to the second polarization prism 417.

The second polarization prism 417 passes the specularly reflected light (P wave) to travel straight to the first light-receiver element 415, and refracts at right angle the diffusely reflected polarized light (S wave) to travel to the second light-receiver element 416.

The first light-receiver element 415 receives the reflected light (P wave) which has travelled straight through the second polarization prism 417, and the second light-receiver element 416 receives the reflected light (S wave) from the second polarization prism 417.

Each of the first light-receiver element 415 and the second light-receiver element 416 is made up from a photoelectric conversion element such as a photo diode that performs photoelectric conversion for outputting voltage corresponding to the amount of received light. Each of the first light-receiver element 415 and the second light-receiver element 416 outputs the voltage obtained by the photoelectric conversion to the difference circuit 41c.

The difference circuit 41c outputs a difference voltage VY obtained by subtracting the output voltage of the second light-receiver element 416 from the output voltage of the first light-receiver element 415. Such subtraction is performed for the following reason.

The Y color toner patch on the photosensitive drum 11Y is made up of layers of toner particles. Therefore, when the Y color toner layers are irradiated with light, the reflected light from the layers are separated into: a specularly-reflected light portion L1 passing through the gaps among the toner particles and reflected off the surface of the photosensitive drum 11Y; a specularly-reflected light portion L2 reflected off the surface of the Y color toner particles; and diffusely-reflected light portion L3 reflected off the surface of the Y color toner particles.

Generally, the gaps among the toner particles decrease in size as the amount of adhering toner per unit area increases. As the gaps decrease in size, the amount of the reflected light (specularly reflected light portion L1 described above) from the surface of the photosensitive drum 11Y decrease accordingly. That is, the amount of the specularly-reflected light portion L1 decreases as the amount of adhering toner increases. Therefore, accurate measurement of the amount of the specularly-reflected light portion L1 leads to accurate measurement of the amount of adhering toner.

However, since the specularly-reflected light portion L1 is received together with the specularly-reflected light portion L2 by the first light-receiver element 415, the first light-receiver element 415 cannot separately measure the amount of specularly-reflected light portion L1.

For this reason, the relationship between the amount of the specularly-reflected light portion L2 and the amount of the diffusely-reflected light portion L3 is obtained in advance by experiments. Here, it is assumed that these amounts are substantially the same. By calculating the above-described difference, it is possible to take into consideration only the amount of the specularly-reflected light portion L1, removing the influence of the reflected light from the Y color toner, and to thereby accurately measure the amount of adhering toner.

When the specularly-reflected light portion L2 and the diffusely-reflected light portion L3 have a significant difference, a correction method for considering the difference and correcting the output voltage of the first light-receiver element 415 may be determined in advance by experiments or the like. By using such a method, it is possible to prevent the measurement accuracy in the same manner as described above.

The output voltage VY from the difference circuit 41c is sent to the control unit 50. Note that the IDC sensor 41M for the M color and the IDC sensor 41C for the C color have the same structure as the IDC sensor 41Y for the Y color, and their respective output voltages VM and VC are sent to the control unit 50.

### <Structure of IDC Sensor 41K>

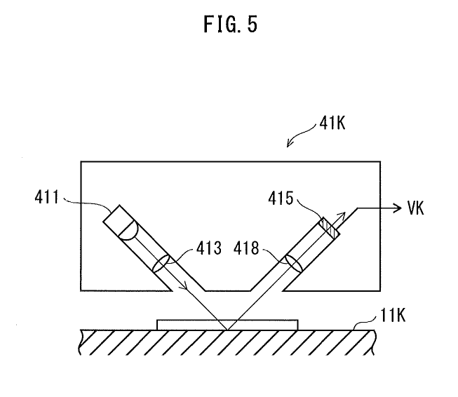

FIG. 5 is a schematic diagram showing the structure of the IDC sensor 41K provided in the image formation unit 10K.

As shown in the drawing, the IDC sensor 41K is not provided with a polarization prism or a difference circuit. The IDC sensor 41K includes a laser beam source 411 and a first collecting lens 413 as the components of a light-emitter, and a first light-receiver element 415 and a second collecting lens 418 as the components of a light-receiver. The IDC sensor 41K is not provided with a polarization prism or a difference circuit because K color toner absorbs almost all of the laser beam emitted by the laser beam source 411, having the wavelength falling within the range of visible light to infrared light, and it is unnecessary to consider the specular reflection and the diffuse reflection from the toner particles.

When K color toner is adhering to the surface of the photosensitive drum 11K, the laser beam emitted by the laser beam source 411 is led to the surface of the photosensitive drum 11K via the first collecting lens 413, and reaches the K color toner formation area on the surface of the photosensitive drum 11K.

The laser beam passes through the gaps among the K color toner particles adhering to the surface of the photosensitive drum 11K, is reflected off the surface of the photosensitive drum 11K, and the reflected light (specularly-reflected light) is received by the first light-receiver element 415 via the second collecting lens 418. The first light-receiver element 415 outputs a voltage VK corresponding to the amount of the received light to the control unit 50.

The control unit 50 monitors the output voltages VY through VK from the IDC sensors 41Y through 41K separately, and based on the output voltages corresponding to the formation areas of the solid patches PS and the non-solid patches PC, measures the amount of adhering toner to each patch, for each of the Y through K colors.

When measuring the amount of adhering toner to the toner patch for each of the Y through K colors, correction of the amount of light to be emitted by the laser beam source 411 is performed immediately before the measurement. In the case of the Y color for example, a blank area on the surface of the photosensitive drum 11Y, where none of the patches P1 through P5 is formed, is irradiated with the laser beam from the laser beam source 411. The amount of the laser beam to be emitted by the laser beam source 411 is corrected so that the output voltage VY from the IDC sensor 41Y corresponding to the amount of the reflected light from the blank area will be a predetermined reference value. By this light amount correction, if variations occur in, for example, the amount of the laser beam reflected off the surface of the photosensitive drum 11Y due to the deterioration of the photosensitive drum 11Y and the amount of the output voltage VY corresponding to the amount of the reflected light due to the production errors of the IDC sensor 41Y, such a variations can be corrected. The same applies to the M through K colors.

### <Control System for Image Formation Unit>

FIG. 6 is a block diagram showing the structure of a control system for the image formation unit 10Y provided in the control unit 50. Note that a control system having basically the same structure is provided in each of the image formation units 10M through 10K. The following only describes about the image formation unit 10Y, and descriptions of the control systems for the other image formation units 10M through 10K are omitted.

As shown in the drawing, the control system for the image formation unit 10Y includes a signal processor 42Y and a unit controller 45Y.

The signal processor 42Y determines the development properties in the image stabilization control according to the output voltage VY from the IDC sensor 41Y. When performing a regular image formation job, the signal processor 42Y sets an appropriate process condition for the job according to the development properties.

The unit controller 45Y controls the amount of electric charge provided by the charger 12Y, the amount of the laser beam for exposure provided by the exposurer 13Y and the development bias voltage Vb provided by the developer 14Y according to the process condition set by the signal processor 42Y, and performs the image formation job.

During the image stabilization control, the unit controller 45Y forms the toner patches P1 through P5 on the photosensitive drum 11Y.

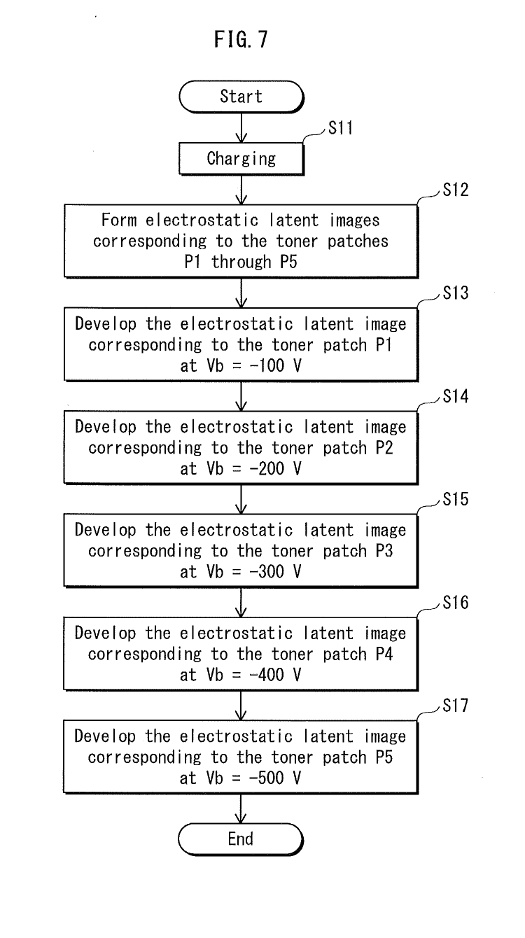

FIG. 7 is a flowchart showing a toner patch formation control.

As shown in the drawing, the charger 12Y uniformly charges the surface of the photosensitive drum 11Y which is being rotated, so that the electrical potential on the surface will be at a predetermined level (Step S11).

Next, the exposurer 13Y emits a predetermined amount of laser beam toward the photosensitive drum 11Y which is being rotated, and thus electrostatic latent images respectively corresponding to the toner patches P1 through P5 are formed on the surface of the photosensitive drum 11Y (Step S12). Image data used for forming the toner patches P1 through P5 is stored in advance. At the toner patch formation, the exposurer 13Y performs exposure of the photosensitive drum 11Y by using the image date, and thereby forms electrostatic latent images for the toner patches P1 through P5 on the photosensitive drum 11Y.

As shown in FIG. 2, the toner patch pair P1 includes the solid patch PS1 and the non-solid patch PC1. The electrostatic latent images used for the forming these two patches are formed on the surface of the photosensitive drum 11Y with a predetermined interval therebetween along the rotational direction of the photosensitive drum 11Y. The same applies to the toner patches P2 through P5. Note that all the electrostatic latent images corresponding to the toner patches P1 through P5 are formed under the same exposure condition.

According to the timing with which the electrostatic latent images corresponding to the toner patches P1 through P5 pass through the development position, the development bias voltage Vb to be applied to the developing roller 14a is switched among the voltages corresponding to the toner patches P1 through P5, and thus the respective electrostatic latent images are developed in the Y color (Steps S13 through S17).

That is: when the electrostatic latent image corresponding to the toner patch pair P1 passes through the development position, the development bias voltage Vb is set at −100 V (Step S13); when the electrostatic latent image corresponding to the toner patch pair P2 passes through the development position, the development bias voltage Vb is set at −200 V (Step S14); when the electrostatic latent image corresponding to the toner patch pair P3 passes through the development position, the development bias voltage Vb is set at −300 V (Step S15); when the electrostatic latent image corresponding to the toner patch pair P4 passes through the development position, the development bias voltage Vb is set at −400 V (Step S16); when the electrostatic latent image corresponding to the toner patch pair P5 passes through the development position, the development bias voltage Vb is set at −500 V (Step S17).

When passing through the development position, each of the electrostatic latent images corresponding to the toner patches P1 through P5 is developed with the Y color toner with the use of the development bias voltage Vb at that time. Thus, the electrostatic latent images are visualized. FIG. 2 shows examples of the toner patches P1 through P5 after the development.

The toner patches P1 through P5 formed on the photosensitive drum 11Y are sequentially detected by the IDC sensor 41Y, and the results of the detection are sent to the signal processor 42Y.

Returning to FIG. 6, the signal processor 42Y includes a patch output calculator 42a, an A/D converter 42b, a voltage table 42c, a patch selector 42d, an adhering toner amount calculator 42e, an adhering toner amount LUT 42f, a development properties determiner 42g, a process condition setter 42m and a process condition LUT 42h.

### <Calculation of Average Output Voltage of IDC Sensor 41Y>

The patch output calculator 42a takes sample values of the output voltage VY of the IDC sensor 41Y for a predetermined period for each of the solid patches PS and non-solid patches PC, and calculates the average value of each sample value. In the following each of the average values thus calculated is referred to as “the average output voltage”.

The patch output calculator 42a calculates the average output voltage for the solid patch PS by averaging the sample voltage values taken when the entire beam spot S of the IDC sensor 41Y is within the solid patch PS, as shown in FIG. 4A.

As for the non-solid patch PC, the patch output calculator 42a calculates the average output voltage by averaging the sample voltage values taken when the entire beam spot S of the IDC sensor 41Y is within the non-solid patch PC, as shown in FIG. 4B.

Note that the solid patch PS does not contain non-adhesion parts, whereas the non-solid patch PC contains the non-adhesion parts. Therefore, even when the amount of adhering toner per unit area of the toner adhesion part in the solid patch PS is the same as the amount of adhering toner per unit area of the toner adhesion part in the non-solid patch PC, the average output voltage for the solid patch PS will be different from the average output voltage for the non-solid patch PC.

The patches P1 through P5 are sequentially formed in this order. Therefore, the average output voltage Vsa1 for the solid patch PS1, the average output voltage Vca1 for the non-solid patch PC1, the average output voltage Vsa2 for the solid patch PS2, the average output voltage Vca2 for the nonsolid patch PC2 . . . the average output voltage Vsa5 for the solid patch PS5 and the average output voltage Vca5 for the non-solid patch PC5 are output from the patch output calculator 42a to the A/D converter 42b in the stated order.

The A/D converter 42b performs A/D conversion every time it receives the average output voltage Vsa or Vca for each toner patch, and writes the average output voltage Vs or Vc after the conversion into the voltage table 42c.

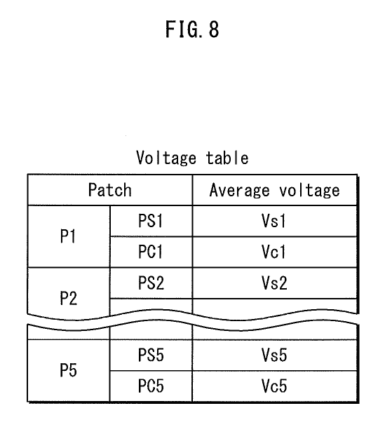

FIG. 8 shows an example of the voltage table 42c.

As shown in the drawing, the voltage table 42c associates the average output voltage Vs for the solid patch PS and the average output voltage Vc for the non-solid patch PC with each of the patches P1 through P5. The average output voltages Vs and Vc for the solid patches PS and the non-solid patches PC can be known from the voltage table 42m.

### <Selection of Patch Used for Determination of Development Properties>

Returning to FIG. 6, the patch selector 42d refers to the voltage table 42c, and for each of the patches P1 through P5, selects either the solid patch PS or the non-solid patch PC to be used for the determination of the development properties.

Specifically, the patch selector 42d selects the solid patch PS for reproduction images with low density (i.e. gradation level), and selects the non-solid patch PC for reproduction images with high density.

This is because when the density is within a low density range, the use of the solid patch PS leads to a higher accuracy in the measurement of the amount of adhering toner, and when the density is within a high density range, the use of the non-solid patch PC leads to a higher accuracy. The following provides further details.

<Relationship Between Development Bias Voltage. Vb and Average Output Voltage Vsa, Vca>

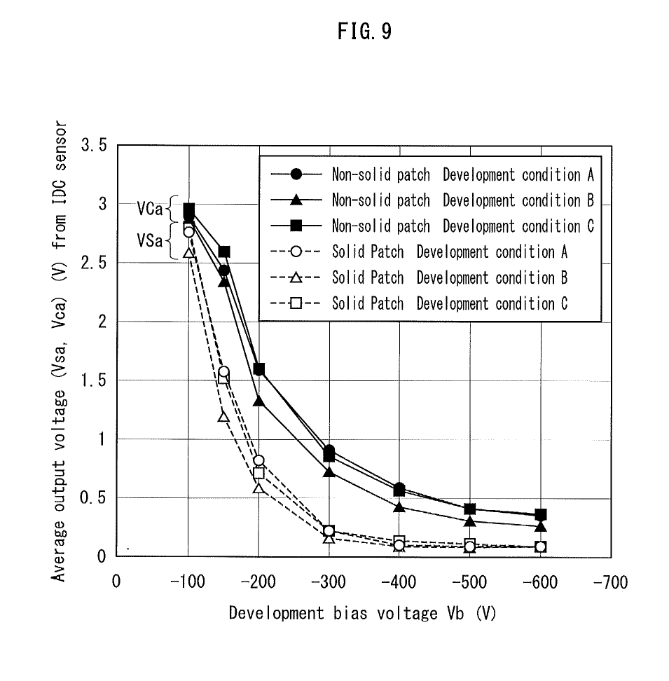

FIG. 9 is a graph showing an example relationship between the development bias voltage Vb and the average output voltage Vsa or Vca. The solid patches PS and the non-solid patches PC are formed at different development bias voltages Vb, and the IDC sensor 41Y detects the patches. The average output voltages Vsa and Vca are calculated based on the results of the detection.

The three solid lines shown in the graph respectively represent the cases where the non-solid patch PC is formed under different development conditions A, B and C, and the three dashed lines respectively represent the cases where the solid patch PS is formed under the development conditions A, B and C.

Each of the development conditions A through C includes the distance between the photosensitive drum 11Y and the developing roller 14a (D-S distance), the amount of developer containing toner on the developing roller 14a, and the amount of electrical charge on the toner. The development conditions A through C are determined to be different from each other within the range of possible instrumental errors such as assembly errors, manufacturing errors, and so on.

Each set of three lines drawn for the solid patches PS and the non-solid patches PC shows that the relationship between the development bias voltage Vb and the average output voltage Vsa or Vca does not change very much even when the development condition changes due to the instrumental errors.

The drawing shows that average output voltages Vsa and Vca from the IDC sensor 41Y decrease with the increasing absolute value of the development bias voltage Vb.

This is for the following reason. As the absolute value of the development bias voltage Vb increases, the amount (i.e. density) of toner adhering to the toner patch increases, and as the amount of the adhering toner increase, the amount of reflection light from the toner patch decreases. The output voltage from the IDC sensor 41Y decreases as the amount of receiving light decreases, and vice versa. Therefore, when the absolute value of the development bias voltage Vb increases, and accordingly the amount of toner amount increases, the amount of reflection light from the toner patch decreases, and accordingly the output voltage from the IDC sensor 41Y decreases.

When comparing the solid lines and the dashed lines, the average output voltages Vca (the solid lines) of the IDC sensor 41Y at the detection of the non-solid patch PC are generally higher than the average output voltages Vsa (the dashed lines) from the IDC sensor 41Y at the detection of the solid patch PS. This is because each non-solid patch PC contains the non-adhesion parts and hence the amount of the light reflected off the surface of the photosensitive drum 11Y is larger than the solid patches PS. When the solid patches PS and the non-solid patches PC are formed at the same development bias voltage Vb, the average output voltage at the detection of each non-solid patch PC is larger than at the detection of the corresponding solid patch PS.

Furthermore, in the range from −300 V to −600 V of the development bias voltage Vb, the dashed lines, which show the average output voltages Vsa corresponding to the solid patches PS, are almost flat, whereas the solid lines, which show the average output voltages Vca corresponding to the non-solid patches PC, have greater amounts of tilt than the dashed lines. It can be considered that this is for the following reasons.

In the solid patch PS, toner adheres to the entire area of the patch almost uniformly, and the non toner adhering parts do not exist in the area. Therefore, when the absolute value of the development bias voltage Vb is increased and the amount of the adhering toner increases accordingly, the solid patch PS increases in its thickness and the surface of the photosensitive drum 11Y will be covered with a thick toner layer.

The laser beam emitted by the light-emitter 41a of the IDC sensor 41Y passes through the gaps among the toner particles in the toner layer, and is reflected off the surface of the photosensitive drum 11Y, and then returns to the light-receiver 41b. Basically, the amount of the light returning to the light-receiver 41h decreases as the thickness of the toner layer increases. However, after the thickness of the toner layer reaches a certain degree, almost no light returns to the light-receiver 41b. As a consequence, the average output voltage will not change any more even if the absolute value of the development bias voltage Vb is further increased.

On the other hand, the non-solid patch PC contains toner adhesion parts and non-adhesion parts. When the absolute value of the development bias voltage Vb is increased and the amount of toner adhering to the toner adhesion parts is accordingly increased, even if the amount of toner per unit area is the same as the solid patch PS, the thickness of the edge of each toner adhesion part of the non-solid patch PC will be greater than the central portion (i.e. the central portion will be thin), due to so-called edge effect.

When the solid patch PS is detected by the IDC sensor 41Y, the diameter of the beam spot S of the laser beam emitted from the light-emitter 41a is smaller than the solid patch PS as shown in FIG. 4A. Therefore, the edge of the solid patch PS is not included in the beam spot S, and the IDC sensor 41Y detects only the light reflected off the toner adhesion part.

In contrast, in the case of the non-solid patch PC, the beam spot S contains the toner adhesion parts composed of segments of a plurality of lines and the non-adhesion parts composed of the gaps among the segments as shown in FIG. 4B. The IDC sensor 41Y detects both the light emitted from the toner adhesion parts and the non-adhesion parts.

That is, the solid patch PS is not subject to influence of the edge effect even when the amount of toner is increased, and the IDC sensor 41Y inevitably detects the reflected light from the uniformly thick toner layer, but the toner adhesion parts of the non-solid patch PC are subject to influence of the edge effect, and even when the amount of adhering toner is the same as the solid patch PS, the IDC sensor 41Y can detect the reflected light from the thin central portions.

As described above, after the thickness of the toner layer has reached a certain degree, it is difficult for the laser beam from the IDC sensor 41Y to pass through the gaps among the toner particles contained in the toner layer, and the amount of reflected light exhibits almost no change when the thickness is increased further. Therefore, within the high density range, the accuracy of the measurement on the solid patch PS is not high.

On the other hand, the non-solid patch PC has thin portions in the toner adhesion parts due to the edge effect, and even when the amount of adhering toner is the same as the solid patch PS, the laser beam can pass through the thin portions. Therefore, within the high density range, the amount of the reflected light is more likely to change according to the changes in the density of the toner (i.e. the amount of adhering toner) than the solid patch PS.

For the reasons described above, in FIG. 9, it is considered that the average output voltages corresponding to the non-solid patches PC represented by the solid lines are higher than the average output voltages represented by the dashed lines corresponding to the solid patches PS, and the amounts of tilt of the solid lines within the high density range are greater than the dashed lines.

The amount of tilt of each line in the graph shows the sensitivity in detecting the amount of change of the development bias voltage Vb, which is the amount of change of the average output voltages Vca and Vsa that change according to the change of the amount of adhering toner (i.e. the density). Therefore, it can be said that a larger amount of tilt shows a higher detection sensitivity. Within the range from −300 V to −600 V of the development bias voltage Vb, the amount of the adhering toner is large (i.e. the density is high), and the amount of the adhering toner can be more accurately measured from the non-solid patch PC than from the solid patch PS.

On the other hand, within the range from −100 V to −300 V of the development bias voltage Vb, the amounts of tilt of the dashed lines corresponding to the solid patch PS are slightly larger than the amounts of tilt of the solid lines corresponding to the non-solid patch PC regardless of the development condition.

This is for the following reasons: with the lowest density at −100 V, the average output voltages corresponding to the solid patch PS and the non-solid patch PC are substantially the same, whereas at approximately −300 V, the average output voltage corresponding to the non-solid patch PC is higher than the average output voltage corresponding to the solid patch PS, and within the range from −100 V to −300 V, the amount of change in the average output voltage corresponding to the non-solid patch PC is larger than the average output voltage corresponding to the solid patch PS.

Also, within the range from approximately −200 V to −300 V, the solid lines corresponding to the non solid patches PC show greater variations according to the development condition. It can be considered that this is for the following reasons.

When focusing on a given segment of one of the vertical or horizontal lines of the lattice-like toner adhesion parts in the non-solid patch PC, and defining the area of the latent image (before development) corresponding to the segment formed on the photosensitive drum 11Y as α and the total length (before development) of the edge of the latent image as β, it is ideal in terms of the reproduction quality of images that the area and the edge length of the segment after development are still α and β, respectively.

However, in the case of the non-solid patch PC, when the absolute value of the development bias voltage Vb is small, the amount of toner adhering to the latent image is small, and therefore the toner is unlikely to adhere to the edge of the latent image. The toner is likely to adhere to the inside of the edge instead, where the edge of the toner adhesion part will be formed after development.

When assuming that the given segment has a rectangular shape, the edge of the latent image before development can be represented by a straight line. After development, however, the edge will be jagged for example. Consequently, the area of the segment after development will be smaller than a, and the edge length after development will be larger than β. For example, when the relationship between α and β is represented as a ratio β/α (toner edge ratio), the toner edge ratio after development is greater than before development.

Such a phenomenon is more likely to occur when the amount of adhering toner is smaller. Since the reproduction quality changes depending on the development condition even if the amount of adhering toner is the same, the average output voltage greatly varies.

On the other hand, when the solid patch PS is detected by the IDC sensor 41Y, no edge exists within the beam spot S. Therefore, independently from the amount of adhering toner, variations in the average output voltage dye to the reproduction quality do not occur, and consequently the variations in the average output voltage are smaller than the non-solid patch PS.

As described above, when optically measuring the amount of adhering toner by using the IDC sensor 41Y, it is possible to more accurately measure the amount of the adhering toner from the solid patch PS than from the non-solid patch PC within the low density range, and it is possible to more accurately measure the amount of the adhering toner from the non-solid patch PC than from the solid patch PS within the high density range.

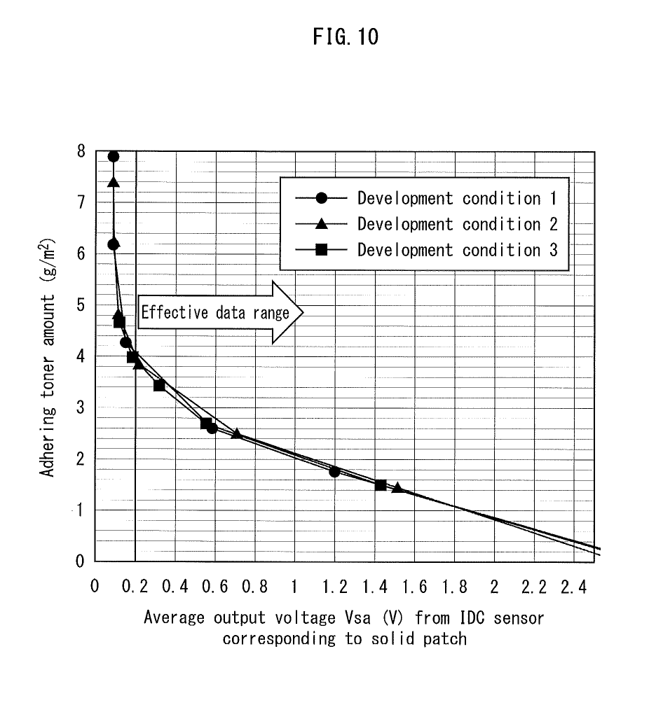

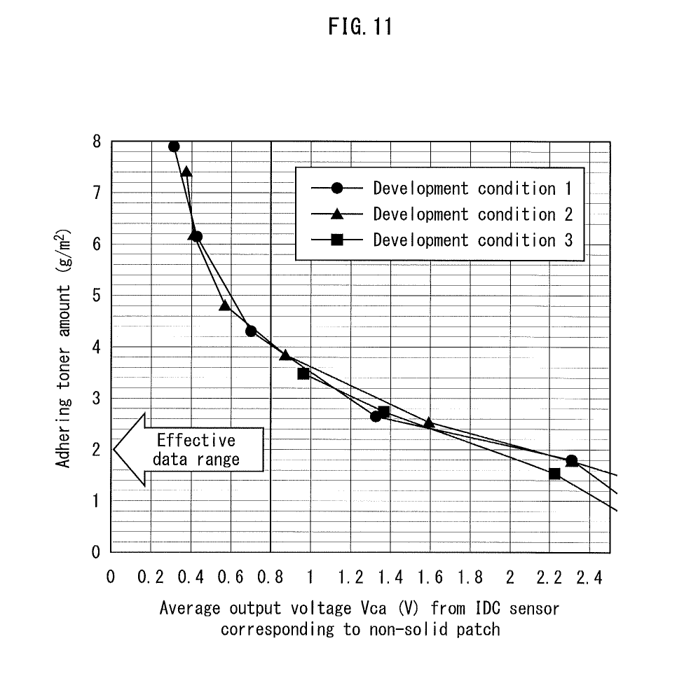

FIG. 10 and FIG. 11 validate this fact.

FIG. 10 is a graph showing the relationship between the average output voltage Vsa of the IDC sensor 41Y in the case of the solid patch PS and the amount of the loner adhering to the solid patch PS.

This graph is obtained in advance by experiments. For the experiments, a plurality of electrostatic latent images corresponding to the solid patches PS were formed on the photosensitive drum 11Y under the same conditions such as those related to charging and exposure, but under different development conditions, namely conditions 1 through 3. The electrostatic latent image corresponding to each solid patch PS is developed with the developer 14 by switching the development bias voltage Vb to −150 V, −200 V, −300 V, −400 V, −500 V and −600 V in this order. Thus, the solid patches PS of toner were formed on the surface of the photosensitive drum 11Y. Note that the development conditions 1 through 3 correspond to the development conditions A through C described above. However, the same results were obtained when the conditions were different.

The amount of the toner adhering to each solid patch PS was measured by the IDC sensor 41Y, and the average output voltage Vsa corresponding to each solid patch PS was calculated. Also, the actual amount of toner contained in each solid patch PS adhering to the photosensitive drum 11Y was measured in a different way, without using the IDC sensor 41Y.

For example, the amount of the toner was measured in the following manner: Transferred each solid patch PS on the photosensitive drum 11Y to a different recording sheet P; and measured the mass of the recording sheet P before and after the transfer to obtain the difference in mass. However, another method may be used for the measurement.

The graph shown in FIG. 10 is obtained by plotting the actual measurement values of the average output voltage Vsa and the amounts of the adhering toner under each of the development conditions 1 through 3.

As shown in the graph in FIG. 10, even under different development conditions, there is almost no variation in the average output voltage Vsa of the IDC sensor 41Y within the range where the amount of the toner adhering to the solid patch PS is smaller than approximately 4 g/m². This means the same as that the dashed line in the graph shown in FIG. 9, corresponding to the solid patch PS, does not show variations within the low density range.

Also, as shown in the graph shown in FIG. 10, the average output voltage Vsa increases inversely proportionally to the decreasing amount of the adhering toner within the range where the amount of the adhering toner is smaller than approximately 4 g/m². Within this range, substantially linear interpolation can be adopted.

On the other hand, when the amount of the adhering toner is greater than 4 g/m², the average output voltage Vsa shows almost no change even when the amount of the adhering toner changes. This means the same as that the dashed line in the graph shown in FIG. 9, corresponding to the solid patch PS, has almost no inclination within the high density range.

FIG. 11 a graph showing the relationship between the average output voltage Vca of the IDC sensor in the case of the non-solid patch PC and the amount of the toner adhering to the toner adhesion parts of the non-solid patch PC, which has been converted into the amount of the toner adhering to the solid patch PS.

Such conversion is performed for the following reasons.

As shown in FIG. 2, in each of the patch pairs P1 through P5, the solid patch PS and the non-solid patch PC are formed at the same development bias voltage Vb. Therefore, the amount of the adhering toner (g/m²) to the toner adhesion part of the solid patch PS is the same as the amount of the adhering toner (g/m²) to the toner adhesion parts of the non-solid patch PC. However, since the non-solid patch PC contains the non-adhesion parts, the average output voltage Vca of the IDC sensor 41Y will be different from Vsa even when the amount of the adhering toner (g/m²) is the same.

The average output voltage Vsa indicates the amount of the adhering toner (g/m²) only to the toner adhesion part of the solid patch PS. Since the average output voltage Vca indicates the average amount of the toner (g/m²) adhering to the toner adhesion parts and the non-adhesion parts of the non-solid patch PC, it is impossible to compare the amounts of adhering toner under the same condition if the conversion of the amount of the adhering toner is not performed.

According to the present embodiment, the density range is divided into the low density range and the high density range with the boundary at a predetermined density (4 g/m² in this example), and the development properties are determined by using the average output voltage Vsa corresponding to the solid patch PS within the low density range, and the average output voltage Vca corresponding to the non-solid patch PC within the high density range.

In the case of dividing the density range into the low density range and the high density range, the comparison between the average output voltage Vsa corresponding to the solid patch PS and the average output voltage Vca corresponding to the non-solid patch PC is preferably made under the same condition for the sake of simplicity. The conversion from the amount of the toner adhering to the non-solid patch PC to the amount of the toner adhering to the solid patch PS is performed for this purpose, and thus the relationship between the converted amount of the adhering toner and the average output voltage Vca is to be obtained.

The graph shown in FIG. 11 is also obtained in advance by experiments. The conditions adopted here are the same as the conditions adopted in the experiments for the solid patch PS.

As shown in the graph in FIG. 11, even under different development conditions, there is almost no variation in the average output voltage Vca of the IDC sensor 41Y within the range where the amount of the toner adhering to the non-solid patch PC is greater than approximately 4 g/m². Also, within this range, the amount of tilt, which shows the change in the amount of the adhering toner in response to the change in the average output voltage Vca, is large. This is presumably for the same reasons as the reasons why the solid lines shown in FIG. 9, which correspond to the non-solid patch PC, have a large amount of tilt within the high density range.

FIG. 11 also shows that the average output voltage Vca varies a lot within the range where the amount of the adhering toner is smaller than approximately 4 g/m². This is presumably for the same reasons as the reasons why the solid lines shown in FIG. 9, which correspond to the non-solid patch PC, vary a lot within the low density range.

As seen from the graphs shown in FIG. 10 and FIG. 11, when the density range is divided into the low density range and the high density range with the boundary at 4 g/m² of the amount of adhering toner, the amount of the adhering toner to the solid patch PS can be accurately measured within the low density range where the average output voltage Vsa is equal to or greater than 0.2 V corresponding to 4 g/m² of the amount of the adhering toner, and the amount of the adhering toner to the non-solid patch PC can be accurately measured within the high density range where the average output voltage Vca is smaller than 0.8 V corresponding to 4 g/m² of the amount of the adhering toner.

Therefore, in the present embodiment, the low density range where the average output voltage Vsa is equal to or greater than 0.2 V is defined for the solid patch PS as a first effective range, and the high density range where the average output voltage Vca is smaller than 0.8 V is defined for the non-solid patch PC as a second effective range.

Regarding the data about the solid patch PS represented by the graph shown in FIG. 10 and the data about the non-solid patch PC represented by the graph shown in FIG. 11, solid patch average output voltage/amount of adhering toner correspondence information and non-solid patch average output voltage/amount of adhering toner correspondence information is stored beforehand in the adhering toner amount LUT 42f, respectively for the solid patch PS and the nonsolid patch PC. Note that the information mentioned above is based on one of the development conditions 1 through 3 that is most similar to the development condition of the printer 100.

Returning to FIG. 6, the patch selector 42d determines, for each patch pair P1 through P5, whether the average output voltage Vs corresponding to the solid patch PS in the pair is within the first effective range, and whether the average output voltage Vc corresponding to the non-solid patch PC in the pair is within the second effective range, and selects one of the pair corresponding to the average output voltage falling within the effective range.

For example, when the first effective range ≧0.2 (V) and the second effective range <0.8 (V), and the average output voltage Vs1 corresponding to the solid patch PS1 in the patch pair P1 satisfies Vs1≧0.2 (V) and the average output voltage Vc1 corresponding to the non-solid patch PC1 in the patch pair P1 satisfies Vc1≧0.8 (V), the average output voltage Vs1 falls within the first effective range, but the average output voltage Ve1 does not fall within the second effective range. Therefore, the patch selector 42d selects the solid patch PS1 from the pair of the solid patch PS1 and the non-solid patch PC1.

Similarly, when the average output voltage Vs5 corresponding to the solid patch PS5 satisfies Vs5<0.2 (V) and the average output voltage Vc5 corresponding to the non-solid patch PC5 satisfies Vc5<0.8 (V), the average output voltage Vs5 does not fall within the first effective range, but the average output voltage Vc5 falls within the second effective range. Therefore, the patch selector 42d selects the non-solid patch PC5 from the pair of the solid patch PS5 and the non-solid patch PC5.

For each of the patch pairs P1 through P5, information showing the selected patch and the average output voltage (the corresponding one of VM1 through VM5) is output to the adhering toner amount calculator 42e.

When both the average output voltages Vs and Vc fall within the respective effective ranges, or none of them fall within the respective effective ranges, the patch selector 42d selects the solid patch PS within the range of the development bias voltage Vb from −100 V to −300 V, and the non-solid patch PC within the range of the development bias voltage Vb from −300 V to −500 V.

This is for the following reason.

As shown in the graph in FIG. 9, within the range of the development bias voltage Vb from −100 V to −300 V, the average output voltage Vsa corresponding to the solid patch PS is stable and does not vary very much according to changes in the development condition compared to the average output voltage Vca corresponding to the non-solid patch PC. Therefore, within this range, the amount of the toner adhering to the solid patch PS can be more accurately measured.

On the other hand, within the range of the development bias voltage Vb from −300 V to −500 V, the amount of the toner adhering to the non-solid patch PC can be more accurately measured compared to the solid patch PS due to the difference in the amount of tilt in the graph.

### <Calculation of Amount of Adhering Toner>

Returning to FIG. 6, the adhering toner amount calculator 42e obtains the amount of adhering toner (g/m²) corresponding to the average output voltage (one of VM1 through VM5) of the patch selected by the patch selector 42d, based on the solid patch average output voltage/amount of adhering toner correspondence information and the non-solid patch average output voltage/amount of adhering toner correspondence information (equivalent to the graphs shown in FIG. 10 and FIG. 11) stored in the adhering toner amount LUT 42f.

For example, suppose that the patch selector 42d selects the solid patches PS1 through PS3 from the patch pairs P1 through P3, and the non-solid patches PC4 and PC5 from the patch pairs P4 and P5. In this case, the solid patch average output voltage/amount of adhering toner correspondence information is referred to for the solid patches PS1 through PS3, and the non-solid patch average output voltage/amount of adhering toner correspondence information is referred to for the non-solid patches PC4 and PC5.

Specifically, in the graph shown in FIG. 10, when the output voltage VM1 corresponding to the solid patch PS1 is 1 V, the amount of adhering toner is 2 g/m², and in the graph shown in FIG. 11, when the output voltage VM5 corresponding to the non-solid patch PC5 is 0.7 V, the amount of adhering toner is 4.3 g/m².

Thus, the amount of adhering toner (X1 through X5) corresponding to the selected patch, namely the solid patch PS or the non-solid patch PC, can be obtained for each of the patches P1 through P5.

Since it is known that the development bias voltage Vb used for forming the patch pairs P1 through P5 is from −100 V to −500 V, the relationship between the adhering toner amount X and the development bias voltage Vb is also known. For example, the development bias voltage Vb corresponding to the adhering toner amount X1 is −100 V.

### <Determination of Development Properties>

The development properties determiner 42g determines, for each of the patch pairs P1 through P5, the relationship (development properties) between the development bias voltage Vb and the adhering toner amount X based on the development bias voltage Vb applied at the formation of the patch pair and on the adhering toner amount (one of X1 through X5) corresponding to the selected patch, namely the solid patch PS or the non-solid patch PC.

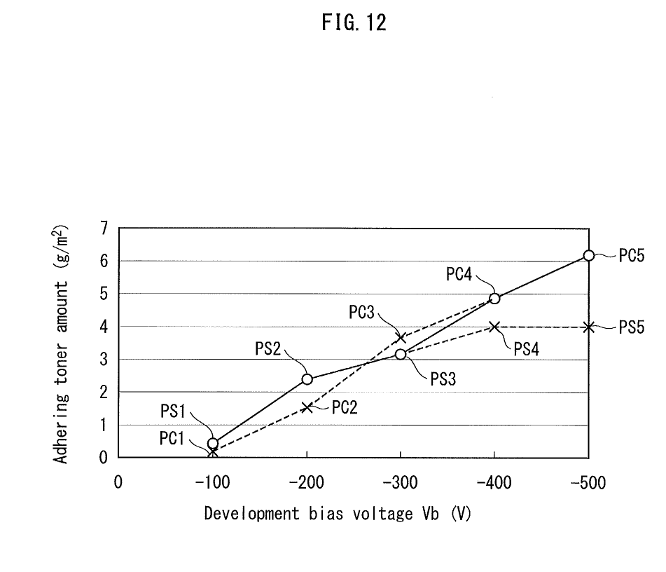

FIG. 12 is an example graph showing the determined development properties. The solid line connects the sings “∘”, which represent the adhering toner amounts X1 through X5 calculated by the adhering toner amount calculator 42e for the selected patches (each being the solid patch PS or the non-solid patch PC) selected by the patch selector 42d from the patch pairs P1 through P5.

The drawing shows an example case where the solid patches PS1 through PS3 and the non-solid patches PC4 and PC5 have been selected. However, for the purpose of comparison, non-selected patches, namely the non-solid patches PC1 through PC3 and the solid patches PS4 and PS5 are also depicted in the graph as the signs “x”, and the dashed line connects these signs.

Note the sings are connected by straight lines because it is known that the adhering toner amount X changes in proportion to the increase in the absolute value of the development bias voltage Vb. If there is no such a proportional relationship, a graph can be obtained by using an appropriate interpolation method.

The development properties determiner 42g obtains the relationship between the development bias voltage Vb and the adhering toner amount X as shown in the graph, based on the adhering toner amounts X1 through X5 obtained by the adhering toner amount calculator 42e. The development properties determiner 42g determines the obtained relationship as the current development properties of the printer 100, and stores data showing the relationship.

The development properties thus stored are used from then on by the process condition setter 42m when executing an image formation job such as a normal print job. Note that the development properties are determined every time the image stabilization control is executed. Therefore, the development properties will be updated sometimes.

### <Determination of Process Condition>

Returning to FIG. 6, the process condition setter 42m determines an appropriate process condition for each image formation job. Based on the development properties stored in the development properties determiner 42g, the process condition setter 42m determines the development bias voltage Vb appropriate for the image formation job, and corrects the conditions other than the development condition, such as charging and exposure conditions.

Specifically, (a) the process condition setter 42m acquires, from the operation unit 40, an image quality mode for the image formation job to be executed. The image quality mode is specified by the user from the operation unit 40.

(b) The process condition setter 42m obtains the adhering toner amount suitable for the acquired image quality mode.

The adhering toner amount is determined in advance for each image quality mode. For example, the adhering toner amount for the character mode is 5 g/m², and the adhering toner amount for the picture mode is 3 g/m². In the case of the character mode, a high sharpness can be realized by reproducing the characters in high density. In the case of the picture mode, the adhering toner amount (i.e. density) is decreased to some extent in order to increase the reproducibility of the halftone colors. When any other modes are available, an appropriate adhering toner amount is determined for each mode.

The adhering toner amount thus obtained will be the target density for forming the toner image on the photosensitive drum 11Y in the specified image quality mode.

(c) The process condition setter 42m obtains the development bias voltage Vb (i.e. the image formation condition) corresponding to the obtained adhering toner amount (i.e. the target density) based on the development properties currently stored in the development properties determiner 42g. In the case of the graph shown in FIG. 12, the development bias voltage Vb corresponding to 5 g/m² for the character mode is −400 V, and the development bias voltage Vb corresponding to 3 g/m² for the picture mode is −280 V.

(d) The process condition setter 42m corrects the image formation conditions other than the development bias voltage Yb, such as the amount of electrical charge (charged voltage or current) and the amount of exposure light (amount of light emission) based on the adhering toner amount thus obtained. Such a correction is performed for realizing image formation with an appropriate image quality that best matches the image quality mode specified by the user.

For the image formation unit 10Y of the present embodiment, a reference value Zs indicating the amount of electrical charge and the amount of exposure light suitable for forming an image by using the reference amount X0 of adhering toner. However, when the adhering toner amount is changed from the reference value X0 according to the specified image quality mode, an image with the desired adhering toner amount cannot be obtained if the amount of electrical charge and the amount of exposure light are not changed from the reference value Zs.

Considering the above, the process condition setter 42m corrects the amount of electrical charge and the amount of exposure light according to the adhering toner amount after the change, and realizes image formation based on the amount of electrical charge and the amount of exposure light thus corrected. The relationship between the adhering toner amount and the amounts of the electrical charge and the exposure light is obtained in advance by experiments, and the information about the relationship is stored in the process condition LUT 42h. This information is read and used at corrections of the amount of the electrical charge and the amount of the exposure light. When the adhering toner amount corresponding to the specified image quality mode is not changed from the reference value X0, it is unnecessary to correct the amount of the electrical charge and the amount of the exposure light, and the reference value Zs is used without change.

After obtaining the development bias voltage Vb, the amount of the electrical charge, and the amount of the exposure light (image formation conditions) that are suitable for the image quality mode for the image formation job to be executed, the process condition setter 42m determines all these image formation conditions as the process conditions for the image formation job, and sends the process conditions to the unit controller 45Y.

At execution of the image formation job, the unit controller 45Y controls the charger 12Y, the exposurer 13Y and the developer 14Y so that the charging, exposure and development are performed according to the process condition determined by the process condition setter 42m. As a result, the printer 100 performs image formation operations based on the process conditions suitable for the image quality mode specified by the user.

Although only the control in the image formation unit 10Y is described above, the same control is adopted in the other image formation units 10M through 10K. In the above description, it is assumed that three conditions, namely the development bias voltage Vb, the amount of electrical charge, and the amount of exposure light, are used as the image formation conditions for realizing the target density of the toner image to be formed on the photosensitive drum 11Y. However, this is not essential. For example, if it is not necessary to correct the amount of electrical charge and the amount of exposure light, only the development bias voltage Vb may be determined as the image formation condition.

As described above, the present embodiment determines the development properties by using the measurement result from the solid patches PS for the low density range and the measurement result from the non-solid patch PC for the high density range. Therefore, unlike conventional technologies that use only the measurement results from solid patches, the present embodiment can avoid the problem that it cannot determine the image formation conditions for the high density range due to the degradation of the accuracy of the measurement, and the present embodiment can improve the image quality of reproduction images.

Furthermore, the present embodiment only needs a sensor for measuring the amount of toner adhering to the solid patches PS and the non-solid patches PC, and unlike conventional technologies, does not need an expensive imaging unit for measuring the thickness of the solid patches PS. Thus, the present embodiment does not lower the cost efficiency.

The present invention is not limited to an image forming apparatus, and may be embodied as a method for determining image density properties such as the development properties. Also, the present invention may be a program that enables a computer to execute the method. The program pertaining to the present invention may be recorded on various kinds of computer readable recording medium on which an optical recording medium such as a magnetic disk, a DVD-ROM and a DVD-RAM, a flash memory type recording medium. The program may for example be produced and transferred in the form of such a recording medium, or may be transmitted and provided via various kinds of wired or wireless networks such as the Internet or broadcasting, an electrical communication, satellite communication, or the likes.

### Modifications

The present invention is described above based on the embodiment. However, the present invention is not limited to the embodiment as a matter of course. The following are possible modifications.

(1) According to the embodiment above, the development bias voltage Vb is changed within the range from −100 V to −500 V in units of 100 V, and both the solid patch PS and the non-solid patch PC are formed in correspondence with a single development bias voltage Vb. However, this is not essential.

For example, only the solid patch PS may be formed for the low density range, and only the non-solid patch PC may be formed for the high-density range. Among the solid patches PS, those with a density not falling within the first effective range, such as PS4 and PS5 in FIG. 2, may not be formed. Similarly, among the non-solid patches PC, those with a density not falling within the second effective range, such as PC1 and PC2 in FIG. 2, may not be formed.

(2) According to the embodiment above, the image quality modes and the target densities used at the execution of a job are associated with each other in advance. For each job, when the user specifies an image quality mode, the target density corresponding to the specified image quality mode is applied to the job. However, the method for obtaining the target density for image formation is not limited to such specification of the image quality mode.

For example, the target density to be applied to the job may be manually specified by the user. Alternatively, the attributes of images such as characters and pictures may be automatically obtained from each page based on the image data. If this is the case, the target density is determined based on the obtained attributes.

Furthermore, the target density is not limited to be variable, and may be fixed to a predetermined value. If this is the case, since the development properties are updated every time the image stabilization control is performed, the developing bias voltage Vb corresponding to the fixed target density may be determined for each job based on the current development properties.

(3) According to the embodiment above, a plurality of solid patches PS and a plurality of non-solid patches PC are formed at different development bias voltages Vb. However, this is not essential. For example, only one solid patch PS and only one non-solid patch may be formed.

Specifically, (a) the single solid patch PS is formed at the development bias voltage Vb for the low density range (e.g. −200 V), and the single non-solid patch PC is formed at the development bias voltage Vb for the high density range (e.g. −400 V) so that the non-solid patch PC has a greater amount of adhering toner per unit area than the solid patch PS has.

(b) The amount of toner adhering to the solid patch PS per unit area and the amount of toner adhering to the toner adhesion part of the non-solid patch PC per unit area are measured.

(c) The development properties are determined based on both (i) the relationship between the development bias voltage Vb applied for forming the solid patch PS and the amount of toner adhering to the solid patch PS and (ii) the relationship between the development bias voltage Vb applied for forming the non-solid patch PC and the amount of toner adhering to the toner adhesion part of the non-solid patch PC.

Such a determination method can be realized by generating a graph as shown in FIG. 12, for example. That is, a graph connecting the point indicating the adhering toner amount Xa of the solid patch PS corresponding to the development bias voltage Vb (e.g. −200 V) applied for formation of the solid patch PS and the point indicating the adhering amount Xb of the non-solid patch PC corresponding to the development bias voltage Vb (e.g. −400 V) applied for formation of the non-solid patch PC is determined as the development properties.

When compared with conventional technologies using only solid patches, the method of generating a graph using the two points as described above is advantageous for the following reasons.

In the case shown in FIG. 12, when using only solid patches like the conventional technologies, the line connecting the points PS3, PS4 and PS5 will be the development properties. Therefore, the development bias voltage Vb can only be set to −400 V both when the adhering toner amount is 4 g/m² and when the adhering toner amount is 5 g/m².

In contrast, when the method using the two points is adopted, in the case shown in FIG. 12, a graph represented by a straight line connecting the points PS2 and PC4 can be obtained. Therefore, the adhering toner amount X is proportional to the development bias voltage Vb even within the high density range greater than 4 g/m².

Thus, when compared with the conventional technologies, the development bias voltage Vb that more appropriate for the adhering toner amount X can be obtained, and at execution of a job, the toner image with a density closer to the target density can be obtained, which leads to the improvement in the quality of the reproduction image.

(4) According to the embodiment above, the non-solid patches PC have a lattice-like shape. However, the shape of the non-solid patches PC is not limited to lattice-like shape. The non-solid patches PC only need to include the toner adhesion parts and the non adhesion parts. For example, one toner adhesion part having a circular shape and a rectangular shape may be formed as an isolated point and other toner adhesion parts adjacent to the isolated point may be formed like dots with gaps therebetween (i.e. dot-like portions arranged in a non-overlapping pattern).

To achieve the edge effect, the magnitude relationship among the toner adhesion parts and the non adhesion parts of the non-solid patch PC and the beam spot S is determined such that at least some of the toner adhesion parts and at least some of the non adhesion parts are included within the beam spot S. That is, the diameter of the beam spot S is determined to be not smaller than the width of the toner adhesion parts so that the edges of the toner adhesion parts are included within the beam spot S.

In the embodiments above, the ratio of the area of the toner adhesion parts of the non-solid patch PC to the patch area (B/W ratio) is set to 50%. However, the B/W ratio is not necessarily 50% and may be changed according to the structure of the apparatus.

Furthermore, the range of the development bias voltage Vb (−100 V to −500 V) and the boundary value of the adhering toner amount between the low density range and the high density range (4 g/m²) are not limited to these values.

(5) According to the embodiment above, the development properties are determined based on the relationship between the development bias voltage (i.e. image formation condition) and the amount of adhering toner. However, the present invention is not limited in such a manner. The present invention may determine image density properties such as charging properties and exposure properties.

Specifically, in the case of the charging properties for the Y color, patch pairs P1 through Pn, each consisting of a Y color solid patch PS and a Y color non-solid patch PC, may be sequentially formed on the photosensitive drum 11Y while changing the charging voltage or current as the image formation condition among n levels, namely Tc1 through Tcn, with other conditions such as the exposure and development condition kept constant. The IDC sensor 41Y detects the solid patch PS and the non-solid patch PC from each of the patch pairs P1 through Pn.

When the IDC sensor 41Y detects each of the solid patch PS and the non-solid patch PC, the relationship between the charging voltage or current and the adhering toner amount (i.e. the relationship is equivalent to the charging properties) can be obtained by using the measurement results from the solid patch PS for the low density range and the measurement results from the non-solid patch PC for the high density range, in the same manner as described above. The same applies to the exposure.

(6) According to the embodiment above, the toner patches are formed on the photosensitive drums, and the amount of toner adhering to each toner patch on the photosensitive drums are measured by the IDC sensor. However, instead of the photosensitive drums, photoreceptor belts, intermediate transfer members such as intermediate transfer belts or intermediate transfer drums, or the likes may be used as the image carriers.

Also, according to the embodiment above, so-called reflection type optical sensors are used as the IDC sensors, whose light-emitter emits a laser beam to the photosensitive drum and whose light-receiver receives the light reflected off the surface of the photosensitive drum. However, the IDC sensors are not necessarily such reflection type optical sensors. For example, when the image carriers are light-transmissive, transmissive type optical sensors may be used instead.

(7) The embodiments above are examples in which the image forming apparatus pertaining to the present invention is adopted in a tandem color printer. However, the present invention is not limited to this. The present invention is applicable to any image forming apparatuses such as copiers, facsimile machines, Multiple Function Peripherals (MFPs) and the likes adapted to form toner patches on the image carrier such as the photosensitive drum or the intermediate transfer member, optically detect the toner patches formed on the image carrier, and determine the image density properties based on the results of the detection, regardless of whether the image forming apparatuses are for forming color images or for forming monochrome images.

The present invention may be any combinations of the Embodiment and Modifications described above.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image forming apparatus for forming a toner image on an image carrier, comprising:
a patch former that forms a solid patch and a non-solid patch respectively on a first area and a second area of the image carrier, under different image formation conditions,
the solid patch being a toner patch to which toner uniformly adheres,
the non-solid patch being a toner patch including: a toner adhesion part to which a greater amount of toner adheres per unit area compared with the solid patch; and a non-adhesion part to which no toner adheres;
a measurer that optically measures an amount of toner adhering to the solid patch and an amount of toner adhering to the non-solid patch;
a determiner that determines image density properties indicating a. relationship between an image formation condition and an amount of adhering toner, based on both (i) a first relationship between an image formation condition applied to the solid patch and the amount of toner adhering to the solid patch, and (ii) a second relationship between an image formation condition applied to the non-solid patch and the amount of toner adhering to the non-solid patch; and
a setter that sets an appropriate image formation condition for forming a toner image having a desired density on the image carrier according to the image density properties determined by the determiner.

2. The image forming apparatus of claim 1, wherein
the patch former forms a plurality of the solid patches and a plurality of the non-solid patches, under different image formation conditions, and
the determiner determines:
the first relationship by using one or more of the solid patches whose densities, derived from results of the measurement by the measurer, fall within a first effective range defined as an appropriate range for determining a low density part of the image density properties; and
the second relationship by using one or more of the non-solid patches whose densities, derived from results of the measurement by the measurer, fall within a second effective range defined as an appropriate range for determining a high density part of the image density properties.

3. The image forming apparatus of claim 1, wherein
the measurer includes:
a light-emitter that emits light toward the image carrier; and
a light-receiver that separately receives a light ray reflected from the solid-patch and a light ray reflected from the non-solid patch, or separately receives a light ray transmitted through the solid-patch and a light ray transmitted through the non-solid patch, and
the measurer measures the amount of toner adhering to the solid patch and the amount of toner adhering to the non-solid patch based on amounts of the reflected light rays or the transmitted light rays received by the light-receiver.

4. The image formation apparatus of claim 3, wherein
the light-emitter forms a beam spot on the image carrier by emitting light to the image carrier, and a size of the beam spot is such that when the light-emitter emits light to the first area, the beam spot entirely lies within the first area, and when the light-emitter emits light to the second area, the beam spot entirely lies within the second area and covers at least a portion of the toner adhesion part and at least a portion of the non-adhesion part.

5. The image formation apparatus of claim 4, wherein
the toner adhesion part of the non-solid patch has a lattice-shape or is composed of a plurality of dot-like portions arranged in a non-overlapping pattern.

6. The image formation apparatus of claim 1, wherein
an area of the toner adhesion part of the non-solid patch is 50% of an area of the second area.

7. The image formation apparatus of claim 1, wherein
the setter acquires the desired density for each toner image formation job, and sets the image formation condition for each toner image formation job according to the desired density.

8. The image formation apparatus of claim 1 further comprising:
a developer that develops an electrostatic latent image on the image carrier by using toner, wherein
the image formation condition is a development bias voltage supplied by the developer,
the image density properties are development properties, and
the toner image on the image carrier is formed by the developer using a development bias voltage corresponding to the desired density, obtained based on the development properties.
